(19) United States
(12) Patent Application Publication
(10) Pub. No.: US 2014/0349622 A1
(43) Pub. Date: Nov. 27, 2014

(54) Telecommunications System and Method for a Mobile Device Allowing Escalation Through Notification Levels

(71) Applicant: George Cessna Graham, Colorado Springs, CO (US)

(72) Inventor: George Cessna Graham, Colorado Springs, CO (US)

(21) Appl. No.: 14/120,244

(22) Filed: May 12, 2014

Related U.S. Application Data
(63) Continuation-in-part of application No. 12/807,074, filed on Aug. 28, 2010, now abandoned.
(60) Provisional application No. 61/278,614, filed on Oct. 9, 2009.

(51) Int. Cl. H04W 68/02; H04M 19/04

(52) U.S. Cl. CPC H04W 68/02; H04M 19/047; H04M 19/042
USPC 455/414.1

(57) ABSTRACT

Upon receipt of a communication, the mobile device performs an escalation from visual to tactile to audible notification. The user can designate particular “contacts” listed in a database as being authorized to send high priority communications to the device. Designated contacts are then able to mark communications as high priority. Upon receipt of a high priority communication from a designated contact, the mobile communication device escalates from visual to tactile to audible notification, but for communications from all other contacts uses a default notification (ie. visual, tactile, or audible).

### CROSS-REFERENCE TO RELATED APPLICATIONS

This application is a Continuation-In-Part of application Ser. No. 12/807,074, filed Aug. 28, 2010, which claims priority from provisional application No. 61/278,614, filed Oct. 9, 2009

### BACKGROUND

Mobile communication devices are an important advancement in telecommunications, allowing their users to remain in touch in places and situations where this had previously been impossible. However, this constant connection often comes at the cost of interruption, embarrassment, and/or annoyance when a mobile communication device rings at a socially awkward or otherwise inconvenient moment. This problem has been partially addressed by the use of vibrate modes, which serve as a more discreet substitute for audible ringtones.

Although vibrate modes are helpful, they are limited in that the user of the mobile communication device may not notice the vibrations from the device. This forces the user to choose between setting the device to give an audible notification to ensure that he or she will notice incoming communications and setting the device to vibrate to reduce the chance that he or she will be embarrassed by an incoming communication. If the user of the device is on call, is expecting an important communication, or needs to be available to his or her children, parents, or spouse, this choice becomes even more difficult.

### SUMMARY

Upon receipt of a data message or voice communication, the mobile communication device performs an escalation from visual to tactile to audible notification. This allows the user of the device to handle the communication discreetly if he or she notices the visual or tactile notifications, but ensures that the user, even if he or she is distracted or busy, will eventually be notified by means of a more noticeable audible notification. If the user does not want an escalation to occur for all data messages or voice communications, he or she is able to designate particular “contacts” listed in a database as being authorized to send high priority communications to the device. Designated contacts are then able to mark communications as high priority if they decide doing so is warranted. Upon receipt of a high priority communication from a designated contact, the mobile communication device escalates from visual to tactile to audible notification, but for communications from all other contacts uses a default notification (ie. visual, tactile, or audible).

### BRIEF DESCRIPTION OF THE FIGURES

FIG. 1 is a block diagram showing the logic executed by software on the mobile communication device to perform an escalation from visual to tactile to audible notification.

FIG. 2 is a block diagram showing the logic executed by software on the mobile communication device to determine whether a communication should be allowed to override the default notification and perform an escalation if the communication is marked as high priority.

FIG. 3 is a block diagram showing the logic executed by software on the wireless service provider or internet telephony provider's network to determine whether voice communications originating from traditional landline telephones or mobile communication devices which are not equipped to mark communications as high priority should be marked as high priority.

FIG. 4 is a rendering of a sample mobile communication device interface which allows the user of the device to designate a particular contact as authorized to send high priority communications.

FIG. 5 is a rendering of a sample mobile communication device interface which allows the user of the device to mark a data message as high priority before sending it to another mobile communication device which is equipped to handle communications marked as high priority.

FIG. 6 is a rendering of a sample mobile communication device interface which allows the user of the device to mark a voice communication as high priority before initiating voice contact with another mobile communication device which is equipped to handle communications marked as high priority.

### DETAILED DESCRIPTION OF THE SYSTEM AND METHOD

An embodiment of the system and method is in a mobile communication device (examples of which include but are not necessarily limited to a cellular telephone, an internet telephony device, a portable entertainment device, or a portable computer) having a wireless connection and/or an internet connection to the network of a wireless service provider or internet telephony provider through which it can send and/or receive voice communications and/or data messages.

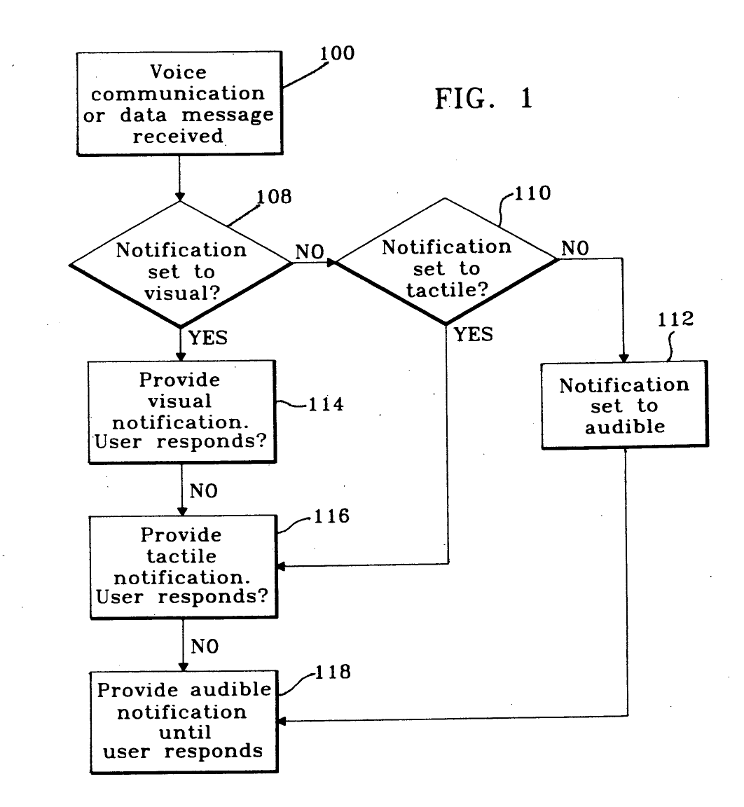

The communication device runs software which (as shown in FIG. 1) upon receipt of a voice communication or a data message (examples of which include but are not necessarily limited to a text, image, or video message) from the wireless service provider or internet telephony provider at block 100 follows a series of logical steps. In block 108, if the user's default notification level is visual, the device continues to block 114; otherwise it continues to block 110. In block 114, the device provides a visual notification, which may include illuminating or changing the illumination of one or more visual indicators, examples of which include but are not necessarily limited to LCDs (Liquid Crystal Displays) and/or LEDs (Light Emitting Diodes). The visual notification may start at a dimmer intensity and gradually increase to a brighter intensity. The device then waits a certain amount of time, which may be set by the user in advance, for the user to respond. If the user does not respond within the allotted time, the device continues to block 116. The device may or may not continue to provide a visual notification. In block 110, if the user's default notification level setting is tactile, the device continues to block 116; otherwise it continues to block 112. In block 116, the device provides a tactile notification by vibrating and waits a set amount of time for the user to respond. The tactile notification may start at a lower vibratory intensity and then gradually increase to a higher vibratory intensity. If there is no response within the allotted time, the device continues to block 118, and may or may not continue to provide a tactile notification and/or a visual notification. In block 112, by process of elimination the default notification level must be audible, so the device continues to block 118. In block 118, the device uses a speaker or other noise generator to provide an audible notification. The audible notification may start at a lower volume intensity and then gradually increase to a higher volume intensity. The audible notification, which may be accompanied by a visual notification and/or tactile notification, then continues indefinitely, or, more likely, for a certain amount of time, which may be set by the user in advance, after which one or more of the notifications might be discontinued. As indicated in FIG. 1, at box 114, if the user does not respond to the notification at the default level of “visual,” the device escalates the notification to the next higher notification level in box 116. If not responded to in box 116, the notification level is again escalated in box 118 until the user responds. Thus the notification levels are escalated within a continuous notification.

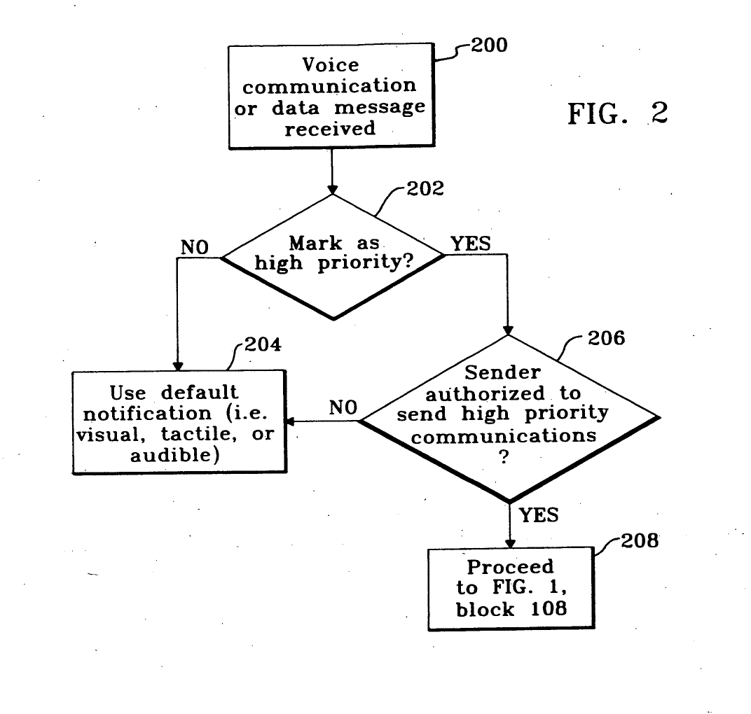

If the user of the mobile communication device does not want an escalation to occur for all data messages or voice communications, he or she can set the device so that, as shown in FIG. 2, upon receipt of a voice communication or a data message at block 200 it follows a different series of logical steps. In block 202, if the voice communication or data message is marked as high priority, the software continues to block 206, and if not, it continues to block 204, in which it uses the default notification (i.e. visual, tactile, or audible) which the user has set in advance. In block 206, the device determines whether the sender of the data message or voice communication is listed in the contacts database as being authorized to send high priority communications. The sender is identified by one or more unique identifiers, examples of which include but are not necessarily limited to a telephone number, IMEI (International Mobile Equipment Identity) code, IMSI (International Mobile Subscriber Identity) code, ESN (Electronic Serial Number) code, MEI (Mobile Equipment Identifier) code, MAC (Media Access Control) address, IP (Internet Protocol) address, user id, screen name, and/or email address. If the sender is listed as authorized, the device continues to block 208; if not, the device continues to block 204 and uses the default notification. Starting in block 208, the mobile device executes logic identical to that described above and shown in FIG. 1.

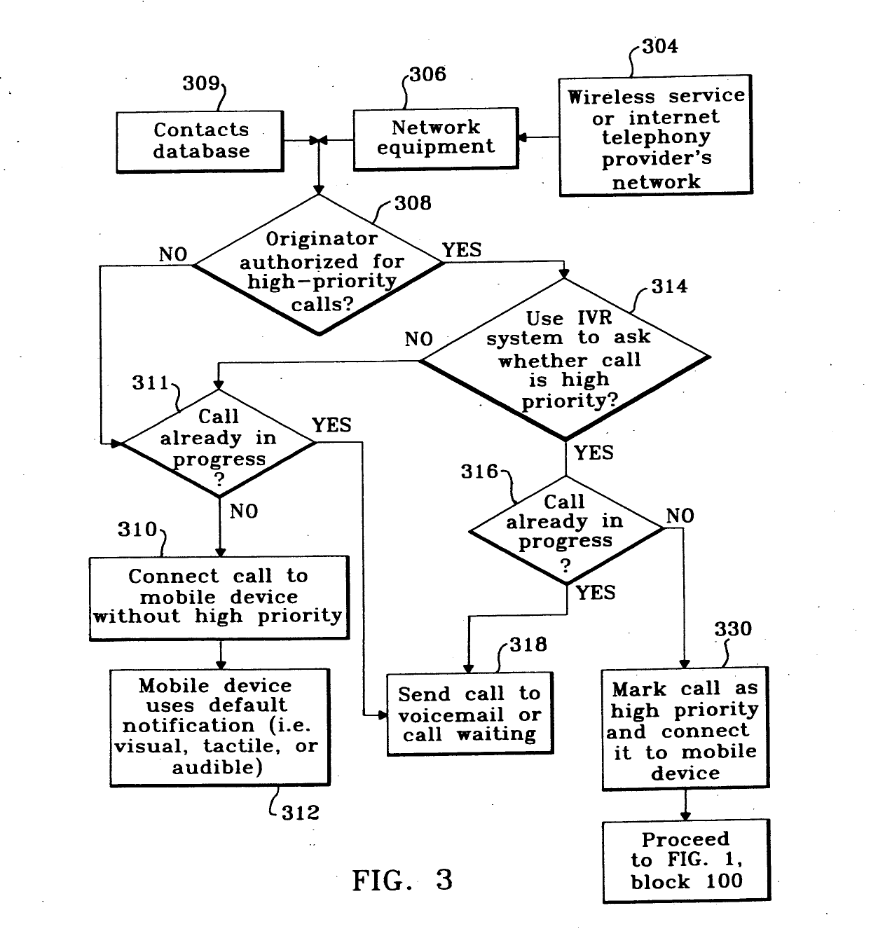

Voice communications originating from traditional landline telephones or mobile communication devices which are not equipped to mark communications as high priority are also contemplated. In such a situation, shown in FIG. 3, a voice communication originator uses a traditional landline telephone or a mobile communication device which is not equipped to mark communications as high priority, the telephone or device being connected either directly or indirectly to the wireless service provider or internet telephony provider's network 304. One or more pieces of network equipment 306, examples of which include but are not necessarily limited to a server or router, execute a software routine illustrated in the remainder of FIG. 3, which, in order to save space, uses the term “call” to mean voice communication.

In block 308, the equipment consults a database 309 which contains a listing of all of the mobile device user's contacts who are authorized to send high priority data messages or voice communications. The database information may be accessed from equipment operated by the provider, having been previously transmitted to the equipment from the mobile device, or it may be accessed from the mobile device directly or from some other source. If the equipment determines, based on one or more unique identifiers, examples of which include but are not necessarily limited to those listed previously, that the incoming voice communication is from a telephone or device associated with a contact authorized to send high priority communications, it continues to block 314; otherwise it continues to block 311. In block 311, the equipment determines whether another voice communication is already in progress on the mobile device which the voice communication originator desires to reach. If yes, the equipment continues to block 318, in which the voice communication is sent to voicemail or call waiting, in accord with typical industry and/or provider practice. Otherwise, in block 310 the equipment connects the voice communication to the mobile device without marking it as high priority, at which point, in block 312 the user's mobile device uses the default notification to notify the user of the incoming voice communication.

In block 314, the network equipment uses some method, an example of which might be an IVR (Interactive Voice Response) system, to determine from the voice communication originator whether the voice communication should be marked as high priority. If yes, the equipment continues to block 316, if no, it continues to block 311 (described above). In block 316, the equipment determines whether another voice communication is already in progress on the mobile device which the voice communication originator desires to reach. If yes, it continues to block 318 (described above); if no, the network equipment in block 330 marks the voice communication as high priority by some method, examples of which include but are not necessarily limited to including a data mask or special packet which precedes the voice communication, producing a unique series of audible tones, or sending a special data message to the device to which the voice communication will be sent, and connects the voice communication to the mobile device. At that point, the mobile device, starting at block 100, executes logic identical to that shown in FIG. 1 and described above. While the voice communication originator is waiting for the voice communication to be responded to, the wireless service provider or internet telephony provider, or the recipient's mobile communication device itself, may provide a message explaining that the voice communication is being connected and asking the voice communication originator to hold.

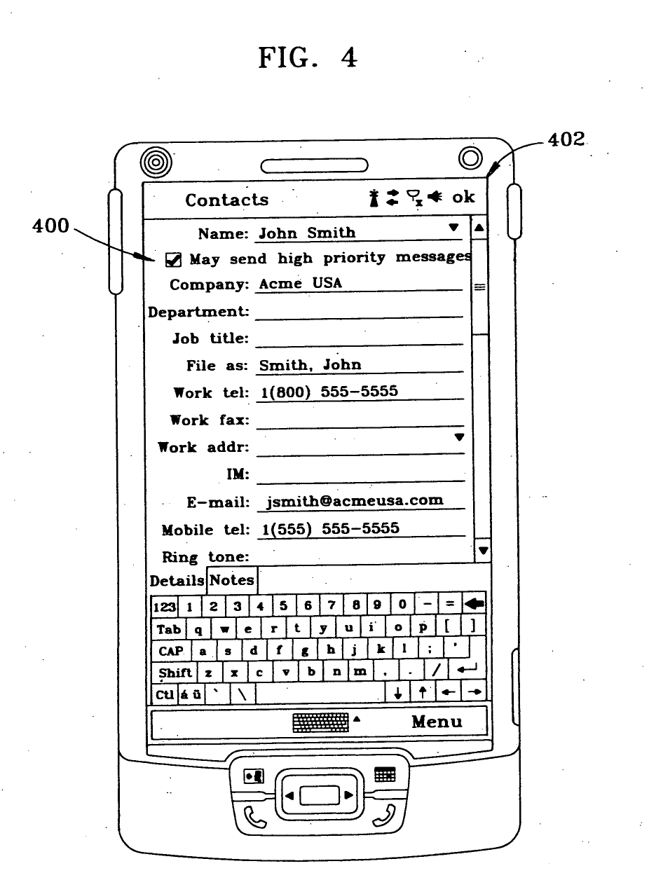

FIG. 4 shows a sample mobile communication device with an interface allowing the user of the device to designate a particular contact as authorized or not authorized to send high priority communications by checking or un-checking check box 400. Although this is not shown in the sample interface, the user could be given the ability to authorize or not authorize the contact to send high priority communications based on the type of the communication (for example voice, text, image, video, etc). Once the user enters at least one unique identifier, examples of which include but are not necessarily limited to those listed previously, he or she presses button 402, at which point an entry in the contacts database is created or updated to reflect the contact's unique identifier information and whether that contact is authorized to send high priority communications. Unique identifier information might be obtained from records of previous communications from the contact.

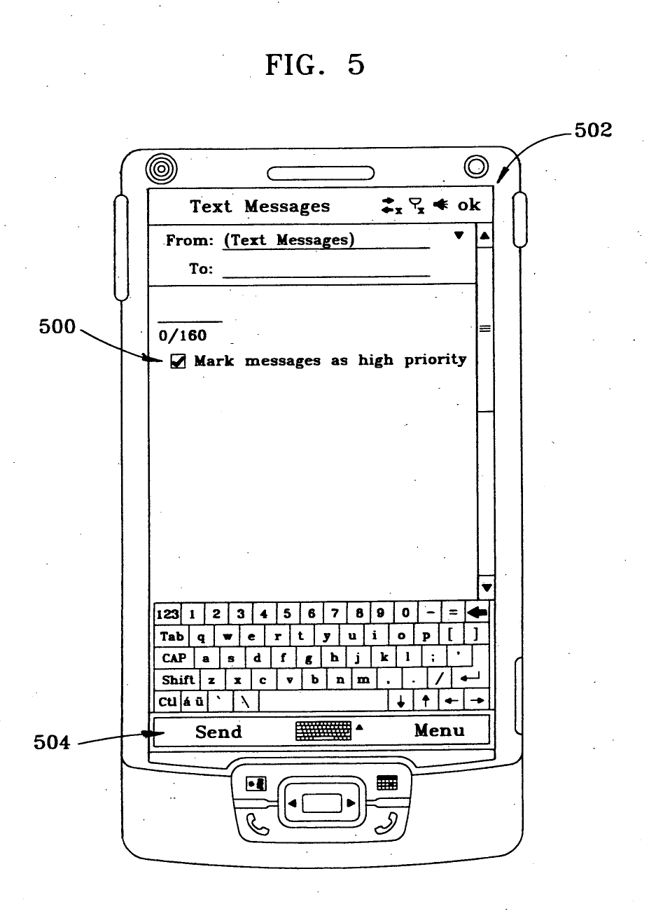

FIG. 5 shows a sample mobile communication device with an interface allowing the user of the device to selectively mark a data message (in this case but not necessarily a text message) as high priority by checking check box 500 before sending the message to another mobile communication device. Once the message has been composed and the user sends it by pressing button 502 or button 504, the device marks the message as high priority by some method, examples of which include but are not necessarily limited to including a data mask, hidden field, special header, special preceding packet, or hidden code, and transmits the message to the wireless service provider or internet telephony provider for delivery. A very similar interface could be used to allow the user of the mobile communication device to mark other types of data message, examples of which include but are not necessarily limited to image or video messages, as high priority.

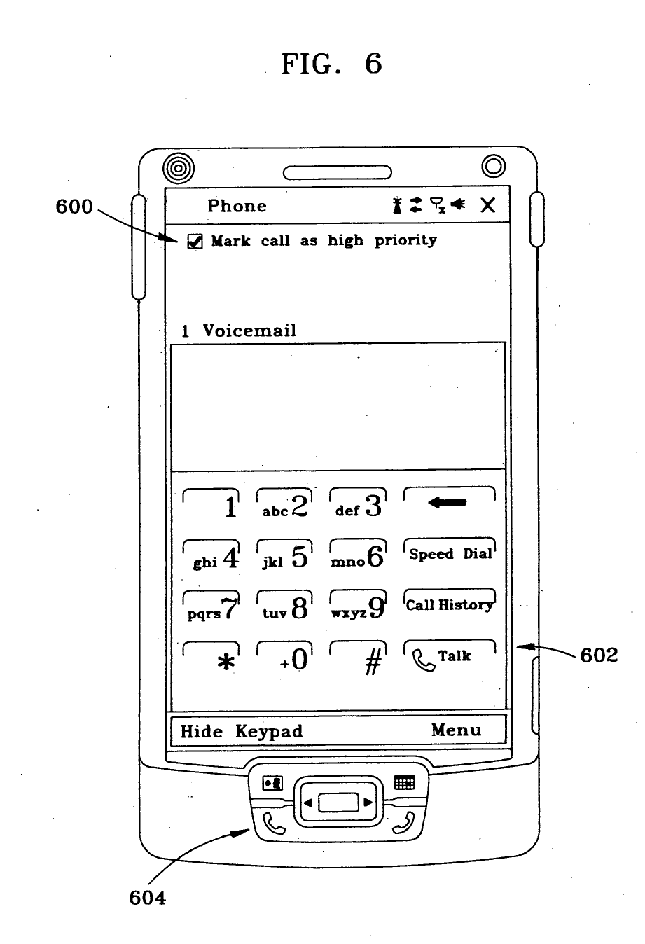

FIG. 6 shows a sample mobile communication device with an interface allowing the user of the device to selectively mark a voice communication as high priority by checking check box 600. Once a number has been dialed or selected, the user presses button 602 or physical button 604 to begin the voice communication, at which point the mobile communication device marks the voice communication as high priority by some method, examples of which include but are not necessarily limited to those listed previously. Once the voice communication has been marked as high priority, the device connects the voice communication to the wireless service provider or internet telephony provider, which then connects the voice communication to the recipient's mobile device, at which point the recipient's mobile device, starting at block 100, executes logic identical to that shown in FIG. 1 and described above.

### Extensions of the System and Method

Several extensions of the system and method are contemplated. In one, the parent, guardian, or caregiver of the mobile device user uses a secured administrative interface on the mobile communication device, an internet interface, or some other method to designate certain contacts as authorized to send high priority communications, one of which designated contacts would presumably be the parent, guardian, or caregiver. The mobile device user could designate additional contacts as authorized to send high priority communications, but could not un-designate the contacts designated by the parent, guardian, or caregiver. This would, for example, allow an adolescent mobile device user to set the device to vibrate due to social considerations while ensuring that an urgent communication from the adolescent's parent or guardian would still get the adolescent's attention.

In another extension, the wireless service provider or internet telephony provider could charge the user of a mobile communication device connected to its network every time that user sends, receives, answers, and/or replies to a communication marked as high priority. The provider could also charge voice communication originators who use the provider's system to mark a voice communication as high priority. Such charges could be very small, but would provide additional revenue for the provider and help discourage frivolous marking of communications as high priority.

In a third extension, the user of a mobile communication device equipped to practice the present invention could designate one or more contacts as contacts all of whose messages should be treated as high priority whether or not they are marked as high priority. This would, for example, allow the user to mark the neighbor of an elderly relative as always high priority, since that neighbor would not send a communication except in an emergency.

1. A method of using a mobile communication device having a connection to a network of a service provider, the mobile communication device being capable of alerting a user to an incoming communication by a notification having a plurality of notification levels, the method comprising the steps of:
a. transmitting a communication to the mobile communication device, the communication being identified as a high priority communication;
b. the mobile communication device, upon receiving the communication, generating a continuous notification at a default notification level for a period of time, the default notification level being set by the user of the mobile communication device;
c. the mobile communication device, after the period of time, escalating the continuous notification to a next higher level for a period of time;
d. repeating step c until the highest notification level is reached: and
e. once the highest notification level is reached, continuing the notification level until the user responds.

2. The method of claim 1 wherein, within one or more notification levels, an intensity of the notification can be varied and wherein the intensity of the notification is gradually increased during the continuous notification at the one or more notification levels.

3. The method of claim 1 wherein the user of the mobile communication device designates contacts in a database from which the mobile communication device will accept and process a high priority communication by the steps b-e above.

4. The method of claim 1 wherein a person other than the user of the mobile communication device designates certain contacts in a database from which the mobile communication device will accept and process a high priority communication by the steps b-e above.

5. The method of claim 4 wherein the user of the mobile communication device designates additional contacts from which the mobile communication device will accept and process a high priority communication by the steps b-e above but is unable to change the designations made by said other person.

6. The method of claim 1 wherein a contact sending a communication selectively marks the communication as high priority.

7. The method of claim 1 further comprising the step of providing to an originator of a voice communication a message telling the originator to wait for the user of the mobile communication device to respond while the notification level on the mobile communication device is escalated.

8. The method of claim 1 wherein the communication is one of a data message and a voice communication.

9. The method of claim 1 further comprising the step of the user of the mobile communication device setting in advance the period of time to wait for the user to respond to each notification level before the notification level is escalated to the next higher notification level.

10. A telecommunications system comprising:
a. a network operated by a wireless service provider or internet telephony provider;
b. first and second mobile communication devices connected to said network;
c. a database of contacts listing certain people designated by a user of the second mobile communication device as people from which the second mobile communication device will accept and process a high priority communication;
d. a user interface on the first mobile communication device allowing a user of the first mobile communication device to selectively mark a communication as high priority before sending it;
e. the network being adapted to receive from the first device the communication marked as high priority and to deliver the communication to the second mobile communication device along with the high priority mark;
f. the second mobile communication device being adapted to determine whether the communication is marked as high priority and, if so marked, confirm that the sender of the high priority communication is designated in the database as a person from which the second mobile communication device will accept and process a high priority communication; and
g. the second mobile device having means for generating a continuous notification first at a default notification level set by the user of the second mobile communication device and then escalating the notification to a next higher level after affording the user a period of time to respond to the notification at the default notification level.

11-12. (canceled)

13. The system of claim 10 wherein the second mobile communication device further comprises means for varying the intensity of a notification within one or more notification levels and wherein the intensity of the notification is gradually increased during the continuous notification at the one or more notification levels when processing a high priority communication.

14. A mobile communication device comprising:
a. means for receiving a communication; and
b. means for generating a continuous notification at a default notification level set by a user of the mobile communication device and then escalating the notification to a next higher notification level after affording the user a period of time to respond to the notification at the default notification level.

15. The mobile communication device of claim 14 further comprising means for designating a contact for which the continuous notification resulting from all communications from the contact will escalate from a default notification level to the next higher notification level after affording the user a period of time to respond to the notification at the default notification level.

16. The mobile communication device of claim 14 further comprising means for determining whether the communication is marked as high priority and if it is so marked, generating the continuous notification at the default notification level set by the user of the mobile communication device and then escalating the continuous notification to the next higher notification level after affording the user the period of time to respond to the notification at the default notification level.

17. The mobile communication device of claim 16 further comprising means for storing a database of contacts of people from which the mobile communication will accept and process communications marked as high priority as high priority communications.

18. The mobile communication device of claim 14 further comprising means for the user of the mobile communication device to set a length of the period of time.

19. The mobile communication device of claim 14 further comprising means for varying the intensity of a notification at one or more notification levels and wherein the intensity of the notification is gradually increased during the continuous notification at the one or more notification levels when processing a high priority communication.
